(19) United States
(12) Patent Application Publication
(10) Pub. No.: US 2016/0059768 A1
(43) Pub. Date: Mar. 3, 2016

(54) METHOD AND DEVICE FOR ADAPTING A BRIGHTNESS OF A HEADLIGHT FOR A VEHICLE

(71) Applicant: Robert Bosch GmbH, Stuttgart (DE)

(72) Inventor: Volker NIEMZ, Leonberg (DE)

(21) Appl. No.: 14/841,912

(22) Filed: Sep. 1, 2015

(30) Foreign Application Priority Data
Sep. 1, 2014 (DE) 10 2014 217 366.3

(51) Int. Cl. B60Q 1/14

(52) U.S. Cl. CPC B60Q 1/1423; B60Q 2300/054; B60Q 2300/30; B60Q 2300/45

(57) ABSTRACT

A method is provided for adapting a brightness of a headlight for a vehicle, the method including a step of determining a headlight control signal for adapting the brightness using a piece of distance information, the piece of distance information representing a distance between the vehicle and an object illuminated or illuminatable by the at least one headlight.

### FIELD OF THE INVENTION

The present invention relates to a method for adapting a brightness of a headlight for a vehicle, to a corresponding device, and to a corresponding computer program.

### BACKGROUND INFORMATION

Presently available displaying video systems for automobiles help the driver when navigating in the immediate surroundings. Using a backup camera, multi-camera top view/bird's eye view, front and side cameras, the actual surroundings may be visualized on a screen. In systems presently available in the market, the driver is able to select the particular view himself. For example, top view offers a bird's eye view, trailer hitch mode creates a transformation of the image section directly behind the trailer hitch to simplify maneuvering processes with a trailer, or rear view creates a normal backup camera view.

### SUMMARY

Against this background, the approach described here introduces an improved method for adapting a brightness of a headlight for a vehicle, furthermore a device which uses this method, and finally a corresponding computer program as recited in the main claims. Advantageous embodiments are derived from the particular subclaims and the following description.

Overexposure of a camera image may be avoided by a short exposure time or by a reduced illumination of the object to be recorded. As the distance between a headlight and an object increases, the object brightness decreases with the headlight brightness remaining the same. A headlight brightness is thus adaptable to a distance from the illuminated object. In this way, overexposure may be avoided, and an objectively and subjectively better camera image may be recorded.

A method for adapting a brightness of a headlight for a vehicle is introduced, the method including the following step:
determining a headlight control signal for adapting the brightness using a piece of distance information which represents a distance between the vehicle and an object illuminated or illuminatable by the headlight.

The vehicle may be a motor vehicle such as a passenger car, a bus or a truck. The vehicle may include at least one headlight. The headlight may be a front headlight, a backup light or another light source of the vehicle. A brightness of the light beam or of the headlight may be adaptable or settable. The brightness may be understood to mean an emitted light quantity of the headlight. The vehicle may include a camera which is designed to record an image, whereby an object in a detection range of the camera may be illuminated by the at least one headlight. The piece of distance information may be understood to mean an analog or digital signal which represents the distance between the vehicle or the at least one headlight of the vehicle and the object.

The piece of distance information may represent a signal from an ultrasonic detection system and, additionally or alternatively from a video sensor system, and additionally or alternatively from a laser sensor, and additionally or alternatively from a LIDAR sensor, and additionally or alternatively from a radar sensor system. As a result of the described sensor systems, a piece of distance information may be provided cost-efficiently and effectively.

The method may include a step of reading in the piece of distance information. In this way, the piece of distance information may be effectively read in as an analog or digital signal and provided to the steps of the method.

The method may include a step of providing the headlight control signal. In this way, the headlight control signal may be effectively provided at an interface for the headlight or for a headlight control unit. The headlight control signal may be provided as a digital or analog headlight control signal.

The headlight control signal may furthermore be determined using a position signal representing a position of the object and/or an angle signal representing a direction with respect to the object. In this way, a more robust headlight control signal may be provided. In this way, the headlight control signal may furthermore be determined using a position signal representing a position of the object and/or an angle signal representing an angle with respect to the object.

It is also favorable if a further headlight control signal for adapting a further brightness of a further headlight of the vehicle is determined using a further piece of distance information which represents a distance between the vehicle and the object illuminated or illuminatable by the further headlight. In this way, a brightness of a headlight may be adapted, and a further brightness of a further headlight may be left unchanged, in an object which is detected or illuminated by only one of the headlights of the vehicle. Advantageously, the brightness of the headlights may be individually adapted for each headlight.

The headlight control signal may furthermore be provided using a piece of brightness information. The piece of brightness information may represent a brightness of the object. A camera may provide a piece of brightness information. The headlight control signal may be adapted in such a way that a predetermined contrast is achieved or a predetermined maximum brightness of the object is adhered to. In this way, a control loop for the brightness of the object is achievable. The brightness of the object may advantageously be set to an objectively or subjectively optimized brightness.

The approach described here furthermore creates a device which is designed to carry out, activate or implement the steps of one variant of a method described here in corresponding devices. The object of the present invention may also be achieved quickly and efficiently by this embodiment variant of the present invention in the form of a device.

A device in the present invention may be understood to mean an electrical device which processes sensor signals and outputs control and/or data signals as a function thereof. The device may include an interface which may be designed as hardware and/or software. In the case of a hardware design, the interfaces may, for example, be part of a so-called system ASIC which includes a wide variety of functions of the device. However, it is also possible for the interfaces to be separate integrated circuits, or to be at least partially composed of discrete elements. In the case of a software design, the interfaces may be software modules which are present on a microcontroller, for example, in addition to other software modules.

In addition, a computer program product or computer program is advantageous, having program code which may be stored on a machine-readable carrier or storage medium such as a semiconductor memory, a hard disk memory or an optical memory, and which is used to carry out, implement and/or activate the steps of the method according to one of the specific embodiments described above, in particular if the program product or program is executed on a computer or a device.

### BRIEF DESCRIPTION OF THE DRAWINGS

FIG. 1 shows a schematic representation of a vehicle having a device for adapting a brightness of a headlight for the vehicle according to one exemplary embodiment of the present invention.

FIG. 2 shows a schematic representation of a device for adapting a brightness of a headlight for a vehicle according to one exemplary embodiment of the present invention.

FIG. 3 shows a flow chart of a method according to one exemplary embodiment of the present invention.

FIG. 4 shows a camera image according to one exemplary embodiment of the present invention.

### DETAILED DESCRIPTION

In the following description of favorable exemplary embodiments of the present invention, identical or similar reference numerals are used for similarly acting elements shown in the different figures, and a repeated description of these elements is dispensed with.

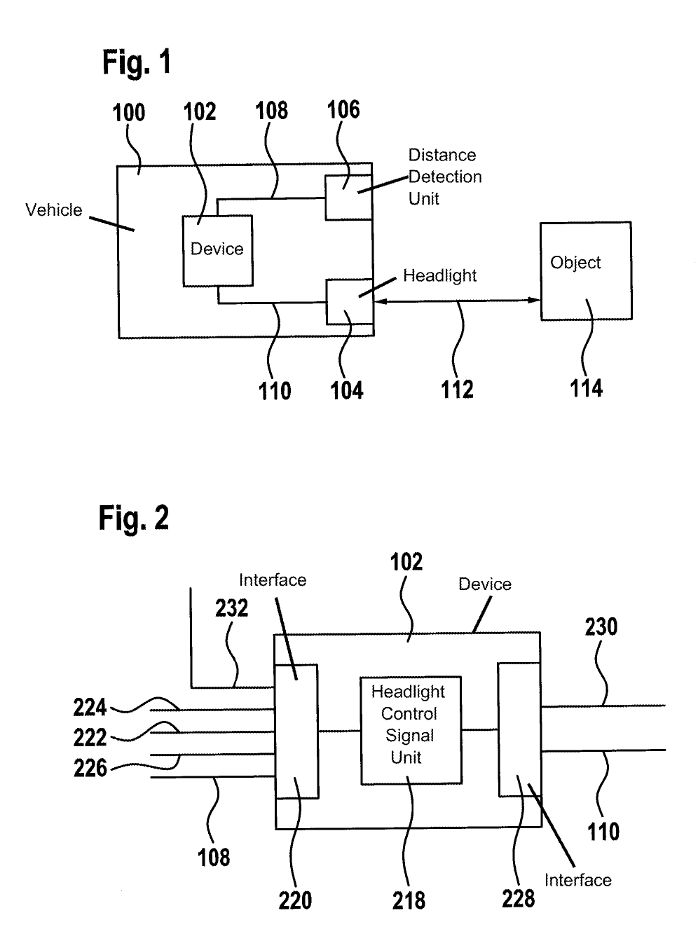

FIG. 1 shows a schematic representation of a vehicle 100 having a device 102 for adapting a brightness of a headlight 104 for vehicle 100 according to one exemplary embodiment of the present invention. In addition to headlight 104 and device 102, vehicle 100 includes a distance detection unit 106. Device 102 is designed to provide a headlight control signal 110 for adapting the brightness of headlight 104 using a piece of distance information 108 provided by distance detection unit 106. The piece of distance information 108 represents a distance 112 between vehicle 100 and an object 114 illuminated or illuminatable by the at least one headlight 104.

Object 114 is situated in a lighting direction in front of headlight 104. Object 114 may be a further vehicle, a pedestrian or an immovable object, for example, such as a house, a wall or a sign.

In one exemplary embodiment, distance detection unit 106 is an ultrasonic detection system, a video sensor system, a laser sensor, a LIDAR sensor or a radar sensor system. Distance detection unit 106 is designed to detect distance 112 from object 114 and to provide a signal corresponding to distance 112 as a piece of distance information 108. Headlight 104 is designed to set the brightness of headlight 104 in response to headlight control signal 110.

Device 102 creates an adaptation of the headlight brightness as a function of an object approach. In particular, a reduction in the headlight brightness is implemented depending on object distance 112 or with a decreasing object distance 112. A normal, unchanged headlight brightness is good when the object is situated at a large or an average distance. If host vehicle 100 is already immediately in front of object 114, for example at a distance 112 of less than two meters, a large portion of the light of headlight 104 is reflected by object 114. This physical condition results in undesirable effects, in particular in camera-based surroundings systems, such as a backup camera or surround-view camera, since object 114 is being illuminated extremely brightly and, as a result of this, less to nothing of object 114 is depicted in the camera image. A corresponding example of a partially overexposed camera image is shown in FIG. 4. In the worst case, overexposure occurs and the depicting camera image is a “white wall.” In addition to object 114, the entire surroundings are often overexposed, whereby contrasts and edges are almost imperceptible.

Device 102 described here for adapting the brightness of headlight 104 for vehicle 100 creates a number of advantages. For example, a camera image is easier to interpret by a driver of vehicle 100. More positive effects than when using better camera technology are thus achievable. In addition, image-processing algorithms such as object recognition are able to supply better results since more image details are identifiable due to a better structure or a higher contrast. In this way, the range of use of surroundings camera systems in situations in which these would possibly be extremely important is extended, for example when maneuvering in a dark underground parking garage or street alley. Depending on the application, advantageously multiple headlights may be controlled separately if an object 114 is situated only locally in a light cone of a headlight, for example when only one corner on vehicle 100 is affected.

FIG. 2 shows a schematic representation of a device 102 for adapting a brightness of a headlight for a vehicle according to one exemplary embodiment of the present invention. Device 102 may be one exemplary embodiment of a device 102 for adapting a brightness of a headlight shown in FIG. 1.

Device 102 is designed to determine a headlight control signal 110 for adapting the brightness using a piece of distance information 108. The piece of distance information 108 represents a distance between the vehicle and an object illuminated or illuminatable by the at least one headlight. For this purpose, device 102 includes a unit 218 for determining headlight control signal 110 for adapting the brightness using the piece of distance information 108.

In the shown exemplary embodiment, device 102 has an optional interface 220 for reading in the piece of distance information 108. Interface 220 is optionally designed, as shown in FIG. 2, to read in a second piece of distance information 222, a position of the object and/or an angle with respect to the object, or a position signal 224 representing the position of the object or an angle signal 226 representing the angle with respect to the object. Unit 218 for determining is designed to receive and process the signals read in by interface 220.

Moreover, device 102 has an optional interface 228 for providing headlight control signal 110 in the exemplary embodiment shown in FIG. 2. Interface 228 is optionally designed to provide a further headlight control signal 230. Unit 218 for determining is designed to determine further headlight control signal 230 for adapting a further brightness of a further headlight of the vehicle using the piece of distance information 108, the second piece of distance information 220, position 222 of the object and, additionally or alternatively, angle 224 with respect to the object. Unit 218 for determining is thus designed to determine the signals provided by interface 228 and to transmit these to the same or to provide the signals to interface 228.

In one exemplary embodiment, interface 220 for reading in is designed to read in a piece of brightness information 232. The piece of brightness information represents a brightness of the object. In the exemplary embodiment, unit 218 for determining is designed to determine headlight control signal 110 using the piece of brightness information 232.

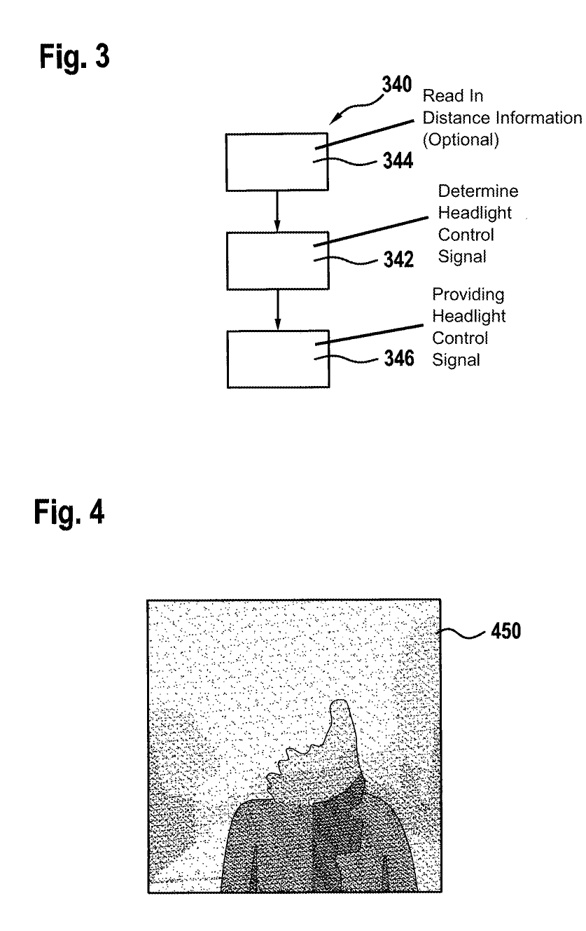

FIG. 3 shows a flow chart of a method 340 according to one exemplary embodiment of the present invention. Method 340 for adapting a brightness of a headlight for a vehicle includes a step 342 for determining a headlight control signal for adapting the brightness using a piece of distance information which represents a distance between the vehicle and an object illuminated or illuminatable by the at least one headlight.

In one exemplary embodiment, method 340 includes an optional step 344 of reading in the piece of distance information prior to step 342 of determining.

In one exemplary embodiment, method 340 includes an optional step 366 of providing the headlight control signal after step 342 of determining. In one particular exemplary embodiment, method 340 includes step 344 of reading in, step 342 of determining, and step 346 of providing.

FIG. 4 shows a camera image 450 according to one exemplary embodiment of the present invention. Camera image 450 may be a camera image 450 recorded by an on-board camera of a vehicle shown in FIG. 1, for example. A person is vaguely discernible on camera image 450. Camera image 450 is overexposed, in particular the upper half containing the head of the person. The depiction size of the person allows a very small distance between the person and the recording camera to be inferred, whereby a headlight illuminating the person causes such overexposure. By using the method described in FIG. 3, it is possible to reduce or avoid the overexposure noticeable in camera image 450.

The described exemplary embodiments shown in the figures are selected only by way of example. Different exemplary embodiments may be combined with each other completely or with respect to individual features. It is also possible to supplement one exemplary embodiment with features of another exemplary embodiment. Moreover, the method steps introduced here may be carried out repeatedly and in a different order than the one described.

If one exemplary embodiment includes an “and/or” linkage between a first feature and a second feature, this should be read in such a way that the exemplary embodiment according to one specific embodiment includes both the first feature and the second feature, and according to an additional specific embodiment includes either only the first feature or only the second feature.

What is claimed is:

1. A method for adapting a brightness of a headlight for a vehicle, comprising:
determining a headlight control signal for adapting the brightness of the headlight using a piece of distance information that represents a distance between the vehicle and an object one of illuminated and illuminatable by the headlight.

2. The method as recited in claim 1, wherein the piece of distance information represents a signal from one of an ultrasonic detection system, a video sensor system, a laser sensor, a LIDAR sensor, and a radar sensor system.

3. The method as recited in claim 1, further comprising reading in the piece of distance information.

4. The method as recited in claim 1, further comprising providing the headlight control signal to an interface to the headlight.

5. The method as recited in claim 1, wherein the determining of the headlight control signal includes determining the headlight control signal using at least one of a position signal representing a position of the object and an angle signal representing a direction with respect to the object.

6. The method as recited in claim 1, wherein the determining of the headlight control signal includes determining a further headlight control signal for adapting the brightness of a further headlight, the determining of the further headlight control signal includes using a further piece of distance information that represents a distance between the vehicle and the object one of illuminated and illuminatable by the further headlight.

7. The method as recited in claim 1, wherein the headlight control signal is provided using a piece of brightness information, the piece of brightness information representing a brightness of the object.

8. A device for adapting a brightness of a headlight for a vehicle, comprising:
a determining unit for determining a headlight control signal for adapting the brightness of the headlight using a piece of distance information which represents a distance between the vehicle and an object one of illuminated and illuminatable by the headlight.

9. A computer program, which is configured to carry out a method for adapting a brightness of a headlight for a vehicle, comprising:
determining a headlight control signal for adapting the brightness of the headlight using a piece of distance information that represents a distance between the vehicle and an object one of illuminated and illuminatable by the headlight.

10. A machine-readable storage medium having a computer program, which is configured to carry out a method for adapting a brightness of a headlight for a vehicle, comprising:
determining a headlight control signal for adapting the brightness of the headlight using a piece of distance information that represents a distance between the vehicle and an object one of illuminated and illuminatable by the headlight.
